(19) United States
(12) Patent Application Publication
(10) Pub. No.: US 2008/0186151 A1
(43) Pub. Date: Aug. 7, 2008

(54) REMOTE POWER CONTROL SYSTEM AND METHOD

(75) Inventor: Chi-Kuang Tsai, Taipei (TW)

Correspondence Address: JJPLUS CORPORATION, P.O.BOX 108-00403, Taipei, 106, omitted

(73) Assignee: JJPLUS CORPORATION, Taipei City (TW)

(21) Appl. No.: 12/021,302

(22) Filed: Jan. 29, 2008

(30) Foreign Application Priority Data
Feb. 5, 2007 (TW) 096104145

(51) Int. Cl. G05B 11/01

(52) U.S. Cl. 340/310.11; 341/176

(57) ABSTRACT

A remote power control system and method for use with a remote wireless transceiver is disclosed to include a solenoid switch for switching on/off multiple power sockets to which controlled machines are connected, sensors installed in different locations to detect different parameters, a wireless transceiver module for communication with the remote wireless transceiver wirelessly, a processor for processing a feedback signal from each sensor and transmitting the feedback signal to the remote wireless transceiver wirelessly through the wireless transceiver module and for processing each control signal received from the remote wireless transceiver through the wireless transceiver module and driving the solenoid switch to switch on/off the power sockets subject to the control signal received.

This application claims the priority benefit of Taiwan patent application number 096104145 filed on Feb. 5, 2007.

### BACKGROUND OF THE INVENTION

1. Field of the Invention

The present invention relates to power control technology and more particularly, to a remote power controls system and method for use to control the power supply of remote machines (xenon lamp exposing machine, automatic teller machine, computer system, etc.) at a remote site, effectively solving labor and time control problems and preventing loss.

2. Description of the Related Art

In offshore or inland fishery, an oxygen generator or supply system, such as air-supply water mill, water wheel, water paddle wheel aerator, etc. may be installed for water quality treatment to provide an optimal environment for fishes, living water animals and water plants. An oxygen generator or supply system may also be used for water treatment to enhance oxidation efficiency and to increase oxygen content in water.

Further, following fast development of modern technology, labor and time management is quite important. In this age of information explosion, we must be prepared to survive in the competitive society. However, the management of some electromechanical equipment such as factory power management systems, automatic teller machines (ATMs), school computers, fishery machines, and etc. that are installed in remote places may encounter following problems.
1. Remote electromechanical equipment may be overheating or may fail after a long period operation. When a remote equipment is unable to function normally, the control center may have to send a mechanic to check and repair the equipment in trouble immediately. This procedure wastes much time and cost. A great damage may occur before the mechanic reaches the site in trouble.
2. In some systems, a control person can control the power supply of a remote equipment through the telephone line. However, before giving the instruction, the control person may give a password to the system for access. This operation procedure takes a certain length of time. In some cases, wasting of this short period may result in a big loss.

Therefore, it is desirable to provide a remote power control system that eliminates the aforesaid problems.

### SUMMARY OF THE INVENTION

The present invention has been accomplished under the circumstances in view. It is one object of the present invention to provide a remote power control system and method, which monitors assigned locations and provides detection data to a remote wireless transceiver for reference so that the controlled machines, in case of a trouble, can be turned off immediately by the remote wireless transceiver by means of a wireless control procedure before sending a person to check the trouble.

To achieve this and other objects of the present invention, the remote power control system and method is to be used with a remote wireless transceiver. The remote power control system and method comprises a solenoid switch for switching on/off multiple power sockets to which controlled machines are connected, multiple sensors installed in different locations to detect different parameters, a wireless transceiver module for communication with the remote wireless transceiver wirelessly to send a sensor feedback signal to the remote wireless transceiver and to receive a control signal from the remote wireless transceiver, a processor for processing the feedback signal from each sensor and transmitting the feedback signal to the remote wireless transceiver wirelessly through the wireless transceiver module and for processing each control signal received from the remote wireless transceiver through the wireless transceiver module, and for driving the solenoid switch to switch on/off the power sockets and the connected machines subject to the control signal received.

### BRIEF DESCRIPTION OF THE DRAWINGS

FIG. 1 is a system block diagram of a remote power control system in accordance with the present invention.

FIG. 2 is a flow chart of a remote power control method in accordance with the present invention.

### DETAILED DESCRIPTION OF THE PREFERRED EMBODIMENT

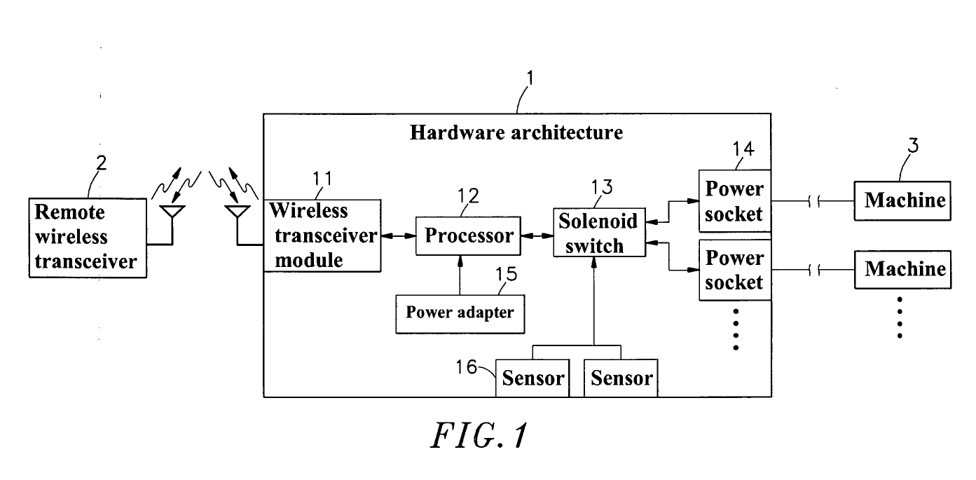

Referring to FIG. 1, a remote power control system in accordance with the present invention is shown comprising a hardware architecture 1. The hardware architecture 1 comprises a wireless transceiver module 11, a processor 12, a solenoid switch 13 (for example, relay), a plurality of power sockets 14, a power adapter 15 and a plurality of sensors 16. The wireless transceiver module 11 is adapted for receiving a power control signal from a remote wireless transceiver 2 and sending it to the processor 12 for processing, and for transmitting a feedback signal from the processor 12 to the remote wireless transceiver 2. Upon receipt of the power control signal, the processor 12 drives the solenoid switch 13 to control the operation of machines (for example, exposing machine or factory machines) 3 that are respectively connected to the power sockets 14. The solenoid switch 13 may provide an automatic control mode (for example, auto-timer control switch) to automatically switch on/off the machines 3 subject to a predetermined setting. Further, the solenoid switch 13 feeds back the operation status of the machines 3 to the processor 12 so that the processor 12 provides the message to the remote wireless transceiver 2 via the wireless transceiver module 11. The sensors 16 detect different parameters (such as monoxide carbon, atmosphere pressure, water level, etc.) and send detected parameters to the processor 12 for transmitting to the remote wireless transceiver 2 via the wireless transceiver module 11. The power adapter 15 provides the hardware architecture 1 with the necessary working voltage.

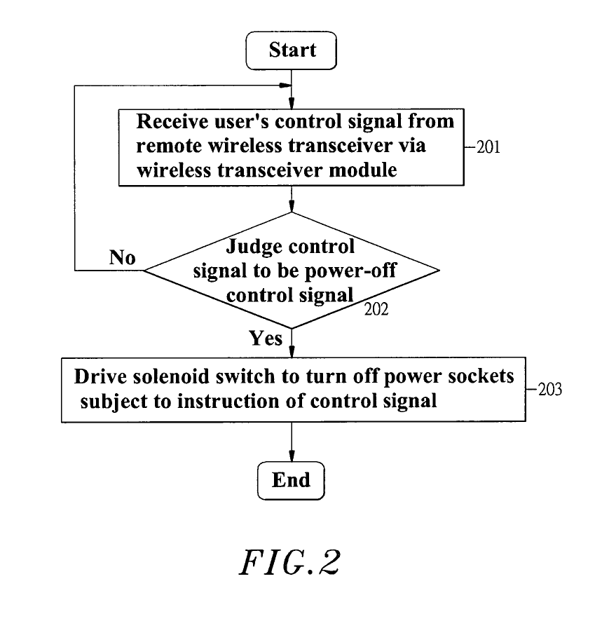

Referring to FIG. 2, when a user is going to turn off power supply from the machines 3, the processor 12 runs subject to the following steps:

(201) The processor 12 receives a control signal from the remote wireless transceiver 2 via the wireless transceiver module 11;

(202) The processor 12 judges whether or not the control signal is a power-off control signal to turn off power supply from the machines 3, and then proceeds to step (203) when positive, or step (201) when negative;

(203) The processor 12 drives the solenoid switch 13 to switch off the power sockets 14, thereby cutting off power supply from the machines 3, and ends the procedure.

Further, the sensors 16 are arranged at different detection locations to detect different parameters, such as monoxide carbon, atmosphere pressure, water level, etc., and to send the detected parameters to the processor 12 through the solenoid switch 13, enabling the processor 12 to feed back the detected parameter data to the remote wireless transceiver 2 wirelessly through the wireless transceiver module 11. Subject to the feedback parameter data, the user can immediately turn off the machines 3 immediately upon occurrence of an extraordinary condition, for example, monoxide carbon content or water level surpassed or dropped below a predetermined level.

As stated above, the remote power control system of the present invention has the following features and advantages:

1. The user can use the remote wireless transceiver 2 to turn on/off the machines 3 wirelessly from a remote place. Upon an abnormal condition of either machine 3, the user can immediately obtain the message and turn off the machine 3 in trouble at the first time, preventing damage and loss.

2. The invention eliminates the complicated password input procedure, facilitating remote power on/off control and achieving the best optimal processing effect.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A remote power control system comprising:
at least one power socket for providing power supply to a respective machine connected thereto;
a solenoid switch adapted for switching on/off said at least one power socket subject to a predetermined control mode set thereof, said solenoid switch being controllable by an external control signal to switch on/off said at least one power socket;
at least one sensor respectively installed in a predetermined location and adapted for detecting a respective parameter and providing a respective feedback signal to said solenoid switch subject to the detection;
a wireless transceiver module adapted for transmitting said feedback signal received from said at least one sensor by said solenoid switch to a remote wireless transceiver and receiving a control signal from said remote wireless transceiver wirelessly for controlling the operation of said solenoid switch;
a processor electrically connected with said solenoid switch and said wireless transceiver module and adapted for processing said feedback signal received from said at least one sensor by said solenoid switch and transmitting said feedback signal to said remote wireless transceiver wirelessly through said wireless transceiver module and for processing each control signal received from said remote wireless transceiver through said wireless transceiver module and driving said solenoid switch to switch on/off said at least one power socket subject to said control signal received; and
a power adapter adapted for providing power supply to said processor, said wireless transceiver module, said solenoid switch, said at least one sensor and said at least one power socket.

2. The remote power control system as claimed in claim 1, wherein said solenoid switch is a relay.

3. A remote power control method comprising the steps of:
a) receiving a control signal from a remote wireless transceiver by a processor via a wireless transceiver module;
b) checking said control signal being a power-off control signal and then turning off power supply from machines; and
c) driving a solenoid switch to switch off power sockets for cutting off power supply from said machines.

4. The remote power control system as claimed in claim 3, wherein said solenoid switch is a relay.
